(19) United States
(12) Patent Application Publication
(10) Pub. No.: US 2025/0001718 A1
(43) Pub. Date: Jan. 2, 2025

(54) Sleeve-Change Calender for Rotary Embossing of a Multi-Ply Tissue Web

(71) Applicants: Matthews International Corporation, Pittsburgh, PA (US); MATTHEWS INTERNATIONAL GMBH, Vreden (DE)

(72) Inventors: Christof RÖRING, Vreden (DE); Jörg GOTTSZKY, Vreden (DE); Frank LAUKAMP, Gronau-Epe (DE); Thomas HACKFORT, Ahaus-Altstätte (DE); Heinz WITTEBROCK, Ahaus (DE)

(21) Appl. No.: 18/707,623

(22) PCT Filed: Aug. 18, 2022
(86) PCT No.: PCT/DE2022/100615

§ 371 Date: May 6, 2024

(30) Foreign Application Priority Data
Nov. 15, 2021 (DE) 10 2021 129 739.7

(51) Int. Cl. B31F 1/07; D21G 1/00

(52) U.S. Cl. CPC B31F 1/07; D21G 1/008; B31F 2201/0776

(57) ABSTRACT

The invention relates to a sleeve-change calender (1) for the rotary embossing of a multi-ply tissue web or for producing a ply bond between the individual plies of the multi-ply tissue web, wherein the sleeve-change calender comprises a roll frame (7) with at least one roll (12, 13) mounted therein, with an expandable support core (3) and a exchangeable sleeve (4) mounted thereon, wherein the sleeve can be pushed onto the support core for assembly and can be fixed thereon with a friction fit, wherein the support core is designed with a multi-chamber system (11) for the individual application of pressure on separate pressure zones (10).

The invention relates to a sleeve-change calender for the rotary embossing of a multi-ply tissue web or for producing a ply bond between the individual plies of the multi-ply tissue web, wherein the sleeve-change calender has a roll frame with at least one roll mounted therein with an expandable support core and a exchangeable sleeve mounted thereon, wherein the sleeve can be pushed onto the support core for assembly and can be fixed thereon with friction fit. A sleeve-change calender is known, for example, from EP 1 967 360 A2.

However, no sleeve-change calender is known from the prior art by means of which different pressures can be generated over the extension of the embossing nip. However, this has the technical advantage that the pressure gradient in the embossing nip can be precisely adapted to the product and pattern to be embossed.

It is therefore the object of the invention to provide a sleeve-change calender which is more flexibly adjustable and produces a better embossing result.

The object is achieved with a device or a method with the features of the independent claims.

Accordingly, it is provided that the support core is designed with a multi-chamber system for the individual application of pressure of separate pressure zones.

The local selectivity in setting the different pressures in the various pressure zones has the advantage that a higher pressure can be provided, particularly in the region of the embossed pattern to be created, and in contrast, regions in which the tissue to be embossed has no embossing can be guided through the embossing nip with a lower pressure. This is particularly important when embossing paper handkerchiefs, where regions with embossing and regions without embossing are created. Usually, several tissue webs are embossed next to each other in the axial direction of the roll. It can be provided that each chamber of the multi-chamber system has at least one pressure zone. The plurality of pressure chambers may be axially spaced from one another. It can be provided that the sleeve-change calender is also designed for embossing textile fabric materials or nonwoven materials.

A tissue web within the meaning of the invention can be a non-woven or a nonwoven fabric. In particular, the tissue web may comprise a tissue material comprising or consisting of paper. For example, the tissue web can be a tissue paper, such as a paper towel, such as a hygiene paper made of cellulose. The tissue web can be used to produce toilet paper, kitchen paper, paper napkins or paper handkerchiefs.

It can be provided that each pressure zone has at least one fluid channel. It can be provided that the support core has a plurality and, for example, at least four different pressure zones. In particular, it can be provided that each pressure zone can be subjected to an individual pressure or that all pressure zones can be subjected to different pressures in order to thereby produce different embossing zones selectively and/or spatially resolved. The pressure zones can be divided along an axial direction of the roll. The pressure zones can have different widths. The pressure zones can all have the same width. This allows the sleeve outer diameter to be changed via pressure, wherein this change can be individually set in the different pressure zones by providing different fluid pressures.

Preferably, the sleeve-change calendar has a three-part structure, with a central support core, onto which a first zone sleeve having the pressure zones is pushed, i.e. shrunk. The exchangeable sleeve with an engraving on its outer circumference is pushed onto its outer circumference. The pressure zones can be formed as recesses on the inside of the zone sleeve facing the support core. At least one fluid channel can open into each of the recesses, via which the pressure zone can be subjected to an individual fluid pressure.

Preferably, the pressure zones are arranged depending on an embossing pattern of the sleeve in order to influence the embossed image of the sleeve. Alternatively or additionally, the different pressure zones can be subject to pressure in such a way that a uniform embossing pressure is provided over the entire length of the calender or the entire width of the tissue web. In particular, the different pressure zones along the length of the calendar can be subjected to such a load that the calendar bulges in the unloaded state, thus having a larger diameter towards the middle compared to regions that are located closer to the end bearings of the calendar. The pressures of the pressure zones can be adjusted in such a way that, in an application in which the calendar is pressed onto a counter roll via its opposing bearing points, an essentially constant embossing pressure is provided over the entire length of the roll, and thus over the entire embossing width.

It can therefore be provided that the sleeve outer diameter can be partially pressure-controlled via differently adjustable hydraulic pressures in the individual pressure zones of the support core. It can be provided that the support core, in particular the first support core element, has at least one rotary feedthrough for the transmission of hydraulic oil.

The pressure zones, or the hydraulic cylinders assigned to the pressure zones, can each be subject to pressure via separate media channels connected to the at least one rotary feedthrough. The support core or the expander can therefore be designed with a multi-chamber system for different pressure loading, with rotary feedthroughs for the transmission of hydraulic oil in separate media channels.

It can be provided that the media channels are designed for a maximum operating pressure of 80 to 400 bar.

The support cores can be configured to ensure that the mounted sleeves remain securely in position in the event of an emergency stop and/or a loss of voltage and/or a shutdown/failure of the hydraulics. For this purpose, the set hydraulic pressure can be clamped in the support core. For example, it can be provided that the hydraulic pressure is maintained via built-in lockable check valves.

It can be provided that the support core is conically ground on the lateral surface and/or coated with a highly wear-resistant material. The highly wear-resistant material can, for example, contain or be chromium or tungsten carbide. This enables a quick sleeve change, as the conical ground surface facilitates quick removal and installation of a sleeve. Chrome plating of the lateral surface also ensures a low coefficient of friction between the inner circumference of the sleeve and the outer circumference of the support core, for example by combining steel with chrome, although other material combinations with the same effect can also be considered.

The sleeve may be made of high-strength tool steel and/or have an engraved surface.

It can be provided that the support core is supported at three points in the roll frame. This results in increased shaft stiffness. The third bearing can be designed as a hydrodynamic plain bearing.

It can be provided that the support core bearing can be temperature controlled via a bearing cooling system, in particular by cooling all support core bearing points. The bearing cooling can, for example, be arranged in the bearing cover. This means that the bearing cooling can be designed to be much larger than with solutions known in prior art. This ensures smoother running and therefore less vibration.

It can be provided that the drive-side bearings are permanently installed in the roll frame or in the slide.

It can also be provided that the bearings on the operating side, which are opposite the bearings on the drive side, are designed as folding bearings and/or that the roll bearings on the operating side can be opened and closed via linear guides. By providing a folding bearing or a linear guide, the bearing can be folded away particularly easily and quickly for a sleeve change, thus creating quick access to the sleeve to be replaced.

Because the bearings on the drive side can be firmly installed in the machine frame or in the slide and the bearings on the operating side can be designed as folding bearings, they can be pulled off and swung away to the side when changing the sleeve.

The sleeve-change calender can also be equipped with a changing device for easy support core or roll change directly in the machine. The rolls or support cores of the sleeve-change calender can be changed with minimal effort via an automatic tensioning system. When changing the sleeve or roll or support core, the bearing on the operating side can be easily opened and closed again using the linear guides or the folding bearings.

In particular, it can be provided that the sleeve-change calender has an upper and a lower roll, wherein the center offset of the upper to the lower roll is adjustable. The advantage is that an adjustable center offset of the upper roll to the lower roll ensures a uniform zero point determination of the bearing during the embossing process.

The sleeve-change calender can also have an active nip control, by means of which the adjustable pressure in the roll nip can be selectively controlled for the different pressure zones. Furthermore, it can be provided that the pressure in the roll nip is hydraulically adjustable. It can be provided that the nip between the upper and lower rolls is adjustable by means of threaded spindles with fine threads, which preferably adjust adjustable wedges that create the nip. The nip adjustment between the lower and upper sleeve embossing rolls can be carried out using the adjustable wedges so that these are adjusted manually or automatically with threaded spindles using a fine thread. A scale may be provided by means of which the nip setting data can be reproduced. Alternatively, it may be provided that they are mechanically adjustable in another way. Furthermore, the wedges can be hydraulically adjustable. In addition, the nip adjustment can be done piezoelectrically. Alternatively, fixed spacers can be provided for this purpose.

Alternatively or additionally, it can be provided that the nip between the upper and lower rolls can be adjusted by means of at least two single- or double-acting hydraulic cylinders for closing and opening the roll nip. Alternatively, the roll nip can also be adjusted via a spindle. The combined mechanical/hydraulic roll adjustment can, for example, be implemented in such a way that the pre-adjustment is carried out hydraulically via the adjustable wedges, wherein the fine adjustment can then be carried out manually with threaded spindles using a fine thread. In addition, it is possible to control and regulate the hydraulic pressure of the roll adjustment differently on both the drive side and the operating side.

It can be provided that the sleeve-change calender has at least one laser referencing unit for detecting the particularly axial and/or radial sleeve position on the support core, wherein the detection of the sleeve position on the support core takes place by means of at least one detectable reference point arranged on the sleeve surface. This allows the sleeves to be set up automatically. Laser referencing ensures that the embossed engraving on the upper and lower sleeves lines up precisely. The laser can automatically detect the reference point or registration mark on the sleeve surface so that the axial and radial adjustment can be carried out automatically. For this purpose, the lower or upper support core can be moved axially by a motor and the radial adjustment can be carried out by the drive motor. The support cores, together with the embossing sleeves mounted on them, can then be driven with precise angles using servo drive motors. If necessary, final fine-tuning can then be done during production via the user interface.

It can be provided that the embossed engravings of the upper and lower rolls can be aligned with each other via the at least one laser referencing unit, wherein the reference points on the sleeve surfaces can be detected via the laser and a corresponding axial and/or radial adjustment of the rolls relative to each other takes place via motor-driven axial adjustment and/or drive motor-induced radial adjustment of at least one of the lower support cores. In the pair of rolls, each of the rolls may have a pair of markings, each pair of markings consisting of a first marking running parallel to the roll axis and a second marking running at an angle between 0° and 90°, preferably 45°, to the first marking. The markings can be arranged in the axial direction at the edge of the upper and lower rolls on the lateral surface. This enables easy scanning of the markings by means of at least one scanning unit, which can be arranged at a distance from the roll surface and thus from the markings.

It can be provided that the roll frame is designed in a closed design and can have side stands with welded cross members as well as integrated vibration-damping components.

The sleeve-change calender can, for example, be designed for the rotary embossing of multi-ply tissue webs. All of the following types of processes can be implemented: dot/dot or alternating or dot/smooth embossing. Embossing creates a ply bond between the individual plies of the multi-ply tissue web. For example, solid rolls, for example with a rubber surface, can also be used for embossing.

The sleeve embossing rolls can be designed as permanently installed, expandable support bodies onto which exchangeable sleeves can be pushed and fixed by pressure and/or friction. These sleeves can be made of high-strength tool steel and have an engraved surface.

It can be provided that the support core adjustment takes place via at least one single- or double-acting hydraulic cylinder. Alternatively or additionally, mechanical means for support core adjustment may also be provided.

It can be provided that the support core bearing has a hydraulic clearance release for the first and/or the second support core element. For example, a set of triple bearings, in particular comprising precision rolling bearings, can be provided with a hydraulic clearance release for the upper and lower support core.

Furthermore, it can be provided that the vertically or horizontally displaceable second support core element is mounted in preloaded and/or ball-bearing precision linear guides in the slide. For example, a set of bearing guides can be provided for the vertically displaceable lower expanding support core, wherein the linear guides can be designed as preloaded and ball-bearing precision linear guides.

The invention further relates to an arrangement comprising a sleeve-change calender of any one of the preceding claims and a sleeve-change carriage which is designed to push sleeves onto the support core or to push sleeves off the support core. The sleeve-change carriage can include an AGV and can therefore be automatically moved towards and away from the sleeve-change calender. The sleeve-change carriage can have a height-adjustable support surface. The support surface can have a roll conveyor, in particular a rubberized one, for moving the sleeves on the sleeve-change carriage. The support surface can be trough-shaped, at least in portions, in order to fix a charged sleeve laterally. The support surface can be designed such that the sleeve-change carriage can receive two sleeves, wherein the arrangement preferably provides that the sleeves lie parallel one above the other on the carriage. This can speed up the sleeve change by loading a “new” sleeve to be mounted on one of the sleeve support positions on the carriage and moving to the sleeve-change calender with the empty sleeve support position. After loading the sleeve to be removed, the sleeve-change carriage changes its position in such a way that the sleeve to be mounted can be pushed onto the support core, for example by moving it sideways or by means of a carousel provided on the sleeve-change carriage, which has two support positions that can be brought alternately in alignment to the calender. This avoids additional trips of the sleeve-change carriage.

The invention also relates to a method for changing a sleeve on a sleeve-change calender as described above, comprising the steps:
front-side positioning of a mobile sleeve-change carriage on the calender;
relaxing the support core;
pushing a sleeve to be dismantled from the support core onto the sleeve-change carriage;
pushing a sleeve to be mounted from the sleeve-change carriage onto the support core.

The method may provide for the sleeves to be pushed on and off manually.

The method may further comprise that the sleeve-change carriage has a pulling device, such as a cable winch or a driven roll conveyor, so that the pushing from the support core or the pushing onto the support core can take place automatically.

The method may further comprise, after sliding a sleeve to be mounted from the sleeve-change carriage onto the support core: aligning the support core by means of the laser referencing unit and clamping the support core. The clamping of the support core can involve generating individual pressures, for example equal or different pressures, in the different pressure zones.

If the bearings on the operating side are designed as folding bearings, the method can further comprise the following steps before pushing a sleeve to be dismantled from the support core onto the sleeve-change carriage: pulling off and laterally swinging the folding bearings away from the roll arrangement.

The removed sleeves can be stored on a separate storage and transport pallet.

The laser referencing units can be used to detect the actual sleeve position on the support cores, which ensures that the embossed engraving on the upper and lower sleeves lines up precisely. The laser detects the registration mark on the sleeve lateral surface, so that the axial and radial adjustment can be carried out automatically based on this information. For this purpose, the lower or upper support core can be moved axially by a motor and the radial adjustment can be carried out by the drive motor.

Furthermore, a quick core change can be carried out. The entire support core can be replaced with another support core, for example with a different diameter, or with a solid roll. For this purpose, the entire drive train can be mounted on a separate console.

Exemplary embodiments of the invention are explained using the following figures. In particular:

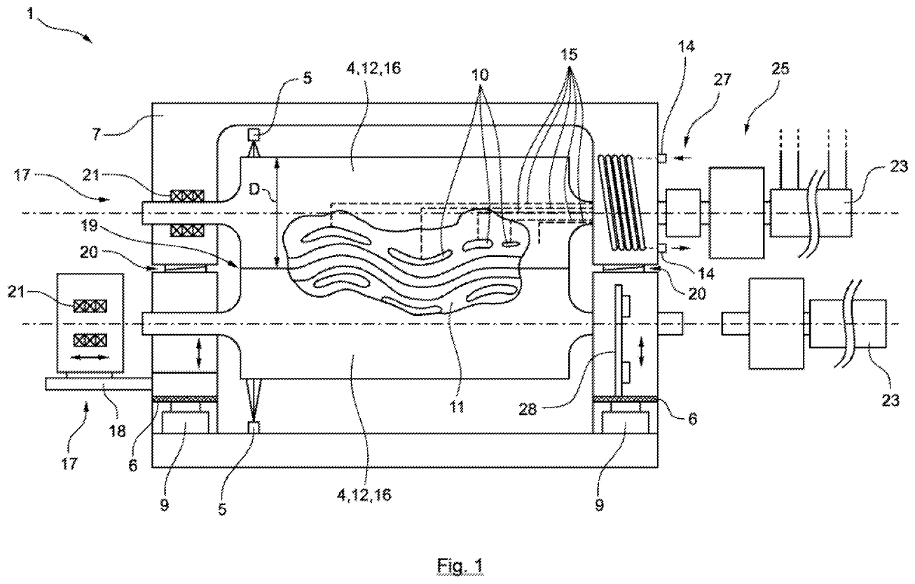

FIG. 1 is a cross-sectional view of an exemplary embodiment of a sleeve-change calender according to the invention;

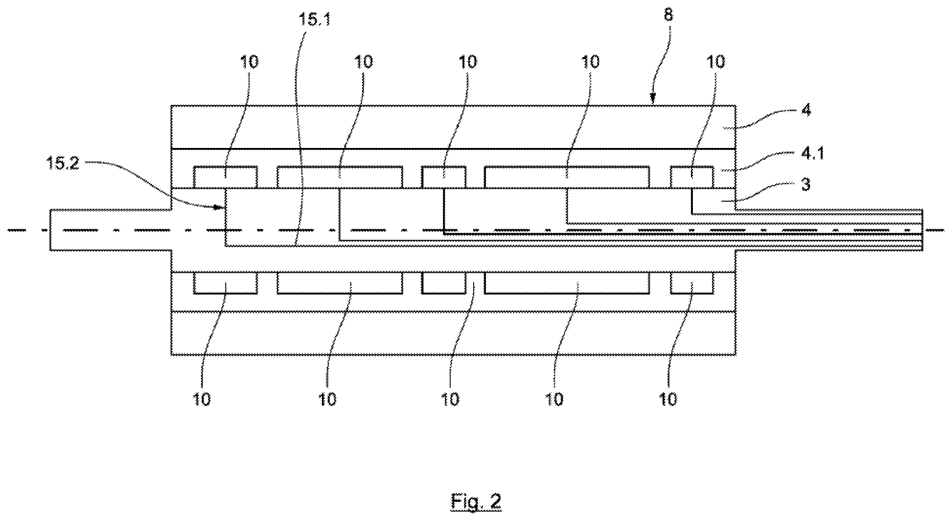

FIG. 2 is a cross-sectional view through a roll of the sleeve-change calender;

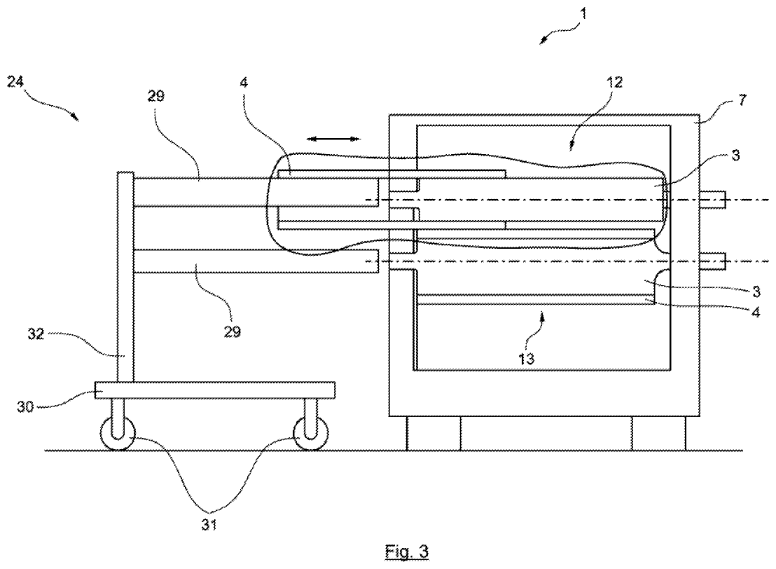

FIG. 3 is a side view of a sleeve-change carriage arranged on a sleeve-change calender according to the invention.

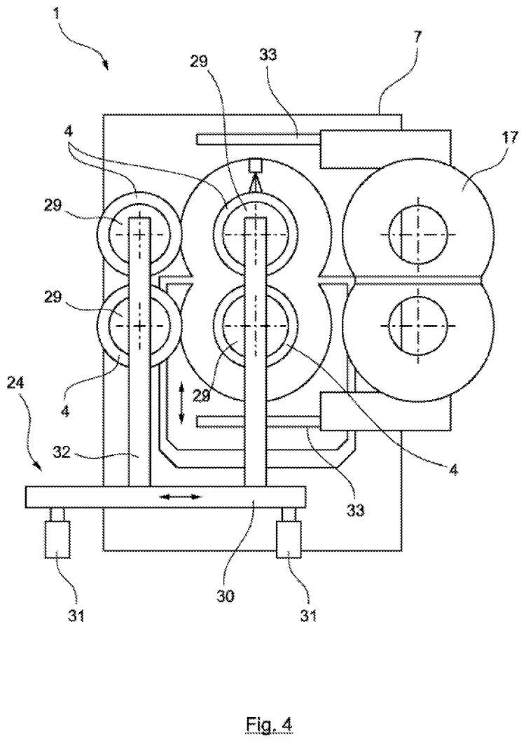

FIG. 4 is a front view of the sleeve-change carriage arranged on the sleeve-change calender.

The sleeve-change calender 1 shown in FIG. 1 has an upper roll 12 and a lower roll 13 mounted in a roll frame 7. A roll nip 19 is formed between the two rolls, between which absorbent and preferably finely creped hygiene paper made of cellulose, such as multi-ply tissue material, can be passed and embossed into a tissue web according to a predetermined pattern. The tissue material can be designed, for example, for use as toilet paper, kitchen paper, paper napkins or paper handkerchiefs. The rolls 12, 13 each have expandable support cores 3, onto which respective exchangeable sleeves 4 are mounted, the lateral surfaces 16 of which roll against one another in the roll nip 19. The roll spacing 19 can be adjusted by means of mutually adjustable wedges 20, which can be adjusted by means of fine threads, whereby the adjusting spindles can have different thread pitches. Thus, beyond a predetermined roll distance, it can be provided that the thread pitch of the spindles is larger than in a region in which the roll nip 19 is small. To minimize vibrations, the roll frame 7 is equipped with vibration dampers 6. The vibration dampers 6 are each arranged between the roll frame 7 and hydraulic cylinders 9 on which the slide 28 is supported. The rolls 12, 13 can be adjusted hydraulically against one another, wherein the upper roll 12 or the support core element 3 of the upper roll 12 is mounted non-adjustably in the roll frame 7 of the sleeve-change calender 1, and wherein the lower roll 13 or the lower support core element 3 is mounted in a slide 28 provided in the roll frame 7, via which the lower support core element 3 can be adjusted hydraulically against the first support core element 3. The slide may comprise a vertical linear guide together with a sliding bearing as shown. The bearing in the roll frame is provided on the drive side 25 and the operating side 17 via triple bearings 21, which achieves increased shaft rigidity. It is provided that the bearing cooling 14 is arranged in the bearing covers and in particular around the bearing points, with each support core bearing point being cooled separately. On the drive side, the rolls 12, 13 are driven in opposite directions by motors 25, which are connected to the rolls via detachable clutches 27. Furthermore, gears are arranged between the motors 25 and the clutches 27, which can in particular be designed as angle gears. The bearings 17 on the operating side can be axially removed from the shaft journals via linear guides 18 and are also designed as folding bearings so that the bearings 17 can be pivoted out laterally from the roll axis. This makes sleeve-changes particularly easy and quick. This allows a sleeve-change carriage 24 to be moved axially towards the sleeve to be changed so that the dismantled sleeve can immediately be pushed horizontally onto a support surface of the sleeve-change carriage 24. A new sleeve can then be mounted in the same way in the opposite direction. Subsequently, the bearings 17 are pivoted back and pushed back onto the respective shaft journal via the linear guide 18. The desired bearing preload can then be set using a hydraulic clearance release. On the drive side, multi-channel rotary feedthroughs 23 are provided, via which different pressure zones 10 of one of the multi-chamber systems 11 provided in the support core can be subjected to individual pressures. The pressure zones 10 are axially spaced from each other and extend annularly in the support core and substantially parallel to the roll axes. Each pressure zone 10 is connected to a separate media channel 15. The detail E shown in FIG. 1 is an exemplary exaggerated detailed representation of the pressure curve in the roll nip 19, wherein the view shows a cross section through the support cores 3 with pressure zones 10. It can be seen that the various axially spaced pressure zones 10 are subjected to different pressures, so that the outer circumference D of the sleeve 4 pulled onto the support core 3 varies in the axial direction, so that different pressures are set accordingly in the roll nip 19. The pressure zones 10 can in particular be designed such that uniformly dimensioned pressure zones 10 are located opposite each other on the upper and lower rolls 12, 13. For the rotational alignment of the upper roll 12 and the lower roll 13 to one another, the sleeve-change calender 1 further comprises laser referencing units 5 which, in the embodiment shown, scan the lower roll 13 from the underside and the upper roll 12 from the upper side in order to measure the respective alignment of the marks provided on the sleeves. To correct the alignment, the two rolls 12, 13 can be rotated relative to each other until the marks are aligned in the exact predetermined position.

FIG. 2 shows a cross-sectional view through one of the rolls, upper roll 12 or lower roll 13, of a sleeve-change calender 1. In it, the multi-chamber system 11 can be seen, which has a plurality of pressure zones 10 in the axial direction of the roll 12, 13, which are formed over the outer circumference of the support core 3 and serve to produce a frictional connection between the support core 3 and the sleeve 4 pushed onto it in the axial direction. The illustrated embodiment shows four pressure zones 10, wherein the pressure zones 10 can each have the same width and preferably extend evenly over the entire roll width. Each pressure zone 10 thus has a width in which it extends in the axial direction over a portion of the roll 12, 13. In addition, each pressure zone 10 is formed annularly in the tangential direction in the support core 3, so that the pressure exerted on the sleeve 4 is uniform over the circumference. Each pressure zone 10 has a separate fluid supply, wherein each fluid channel 15 has a first portion 15.1 which extends in the axial direction through the support core, and a second portion 15.2 which branches off vertically in the radial direction from the first portion 15.1 and opens into the corresponding pressure zone 10 which is assigned to the respective fluid channel 15.

Preferably, the sleeve-change calendar 1 has a three-part structure, with a central support core 3, onto which a first zone sleeve having the pressure zones 10 is pushed, i.e. shrunk. The exchangeable sleeve 4 with an engraving 8 on its outer circumference is pushed onto its outer circumference. The pressure zones 10 are formed as recesses on the inside of the zone sleeve facing the support core 3. At least one of the fluid channels 15 opens into each of the recesses.

FIG. 3 shows a side view of a sleeve-change carriage 24 arranged on a sleeve-change calender 1 according to the invention. In the illustration, the process of pulling the sleeve 4 off the support core 3 of the upper roll 12 takes place, wherein the sleeve 4 is pushed in the horizontal direction onto an upper sleeve receiving device 29 of the sleeve-change carriage 24. To change the sleeve 4, the sleeve receiving device 29 is moved towards the sleeve-change calender 1 in such a way that the upper side of the receiving device 29 receiving the sleeve 4 is aligned with the upper side of the support core 3 of the roll 12, 13 the sleeve of which is to be replaced. To remove the sleeve 4, the sleeve-change carriage 29 can have a motor-operated removal device, for example multiple driven rolls on which the sleeve can be moved horizontally. The sleeve-change carriage 24 can have two sleeve receiving devices 29 arranged vertically one above the other, so that the sleeve-change carriage 24 can receive both sleeves 4 of the upper and lower rolls 12, 13 at once. The sleeve receiving devices 29 can be attached to the sleeve-change carriage 24 in a height-adjustable manner. This allows the sleeve receiving devices 29 to be brought into an aligned transfer position one after the other with the sleeve 4 to be removed. Alternatively, it can be provided that the vertical distance between the sleeve receiving devices 29 is set such that when the sleeve-change carriage 24 approaches the sleeve-change calender 1, both sleeve receiving devices 29 are already aligned with the respective support cores 3. The sleeve-change carriage 24 has a chassis 30 with rollers 31, wherein a holding frame 32 is mounted on the chassis 30, to which the sleeve receiving devices 29 are fastened.

FIG. 4 shows a front view of the sleeve-change carriage 24 arranged at the operator-side end of the sleeve-change calender 1 during the sleeve-change process. It can be seen that the bearings 17 on the operating side have been pulled off the support cores 3 in the axial direction and moved away laterally, i.e. radially, via a horizontal linear guide 33 so that the sleeve can be changed. The horizontal linear guide 33 is mounted on the roll frame 7. In particular, it can be provided that the sleeve-change carriage 24 and/or the sleeve-change calender 1 have a positioning device by means of which the sleeve-change carriage 24 can be positioned in a self-centering manner on the sleeve-change calender 1, so that the sleeve change can take place as soon as the sleeve-change carriage 24 has been moved towards the sleeve-change calender 1. As indicated in FIG. 4, the sleeve receiving devices 29 are mounted on the sleeve-change carriage 24 so as to be adjustable both in height and laterally. It can be provided that the holding frame 32 is movable relative to the chassis 30. Furthermore, it can be provided that the sleeve-change carriage 24 can have two or four sleeve receiving devices 29. In an embodiment with four sleeve receiving devices 29, it is possible to bring two new sleeves 4 along for the sleeve change, so that first the sleeves 4 to be replaced are removed, then either the sleeve receiving devices 29 are adjusted laterally on the sleeve-change carriage or the sleeve-change carriage 24 is moved sideways in order to then pull the sleeves 4 to be pulled along onto the support cores 3.

The features of the invention disclosed in the above description, in the figures and in the claims can be essential for the implementation of the invention both individually and in any combination.

### LIST OF REFERENCE NUMERALS

1 sleeve-change calender
3 support core
4 sleeve
4.1 zone sleeve
5 laser referencing unit
6 vibration dampers
7 roll frame
8 engraving
9 hydraulic cylinder
10 pressure zone
11 multi-chamber system
12 upper roll
13 lower roll
14 bearing cooling
15 media channel
16 lateral surface
17 operating side bearing
18 linear guide
19 roll nip
20 wedges
21 triple bearing
23 rotary feedthrough
24 sleeve-change carriages
25 drive motor/drive side
27 clutch
28 slide
29 sleeve holding device
30 chassis
31 rollers
32 support frame
33 linear guide
D sleeve outer diameter
E exaggerated detail of the pressure curve in the roll nip

1. A sleeve-change calender for the rotary embossing of a multi-ply tissue web or for producing a ply bond between the individual plies of the multi-ply tissue web, wherein the sleeve-change calender has a roll frame with at least one roll mounted therein with an expandable support core and a exchangeable sleeve mounted thereon, wherein the sleeve can be pushed onto the support core for assembly and can be fixed thereon with a friction fit, characterized in that the support core is designed with a multi-chamber system for the individual application of pressure on separate pressure zones.

2. The sleeve-change calender of claim 1, wherein the pressure zones can each be subjected to an individually adjustable pressure in order to thereby produce different embossing zones in a selective and/or spatially resolved manner, wherein the pressure zones are divided along an axial direction of the roll.

3. The sleeve-change calender of claim 1, wherein the sleeve outer diameter is partially adjustable in a pressure-controlled manner via differently adjustable hydraulic pressures in the individual pressure zones of the support core.

4. The sleeve-change calender of claim 1, wherein the support core, in particular the first support core element, has at least one rotary feedthrough for the transmission of hydraulic oil.

5. The sleeve-change calender of claim 4, wherein the pressure zones, or the hydraulic cylinders assigned to the pressure zones, can each be subjected to pressure via separate media channels connected to the at least one rotary feedthrough.

6. The sleeve-change calender of claim 1, wherein the support core is conically ground on the lateral surface and/or coated with a highly wear-resistant material.

7. The sleeve-change calender of claim 1, wherein the sleeve is made of high-strength tool steel and/or has an engraved surface.

8. The sleeve-change calender of claim 1, wherein the support core is mounted at three points in the roll frame.

9. The sleeve-change calender of claim 1, wherein a support core bearing of the support core is tempered via a bearing cooling, in particular by cooling all support core bearing points.

10. The sleeve-change calender of claim 8, wherein drive-side bearings are firmly installed in the roll frame or in the carriage.

11. The sleeve-change calender of claim 8, wherein operator-side bearings are designed as folding bearings and/or the operator-side roll bearings can be opened and closed via linear guides and/or ball bushings.

12. The sleeve-change calender of claim 1 any one of the preceding claims, in which the at least one roll mounted in the roll frame has an upper roll and a lower roll, wherein the center offset of the upper roll to the lower roll is adjustable.

13. The sleeve-change calender of claim 12, which further comprises an active nip control, by means of which the adjustable pressure in the roll nip formed between the upper and lower rolls can be selectively controlled for the different pressure zones.

14. The sleeve-change calender of claim 13, wherein the nip between the upper and lower roll is adjustable by means of threaded spindles having fine threads, which preferably adjust adjustable wedges creating the nip.

15. The sleeve-change calender of claim 13, wherein the nip between the upper and lower roll is additionally adjustable by means of at least two single- or double-acting hydraulic cylinders for closing and opening the roll nip.

16. The sleeve-change calender of claim 1 any one of the preceding claims, which has at least one laser referencing unit for detecting the sleeve position on the support core, wherein the detection of the sleeve position on the support core takes place by means of at least one detectable reference point arranged on the sleeve surface.

17. The sleeve-change calender of claim 16, wherein the embossed engravings of the upper and lower roll can be aligned with each other via the at least one laser referencing unit, wherein the reference points on the sleeve lateral surfaces can be detected via the laser and a corresponding axial and/or radial adjustment of the rolls relative to each other takes place via motor-driven axial adjustment and/or drive motor-induced radial adjustment of at least one of the support cores.

18. The sleeve-change calender of claim 1, wherein the roll frame is designed in a closed construction and has side stands with cross members welded thereto and integrated vibration-damping components.

19. An arrangement comprising a sleeve-change calender of claim 1 any one of the preceding claims and a sleeve-change carriage which is designed to push sleeves onto the support core or to push sleeves off the support core.

20. A method for changing a sleeve on a sleeve-change calender of claim 1, comprising the steps of:
front-side positioning of a mobile sleeve-change carriage on the calender;
relaxing the support core;
pushing a sleeve to be dismantled from the support core onto the sleeve-change carriage;
pushing a sleeve to be mounted from the sleeve-change carriage onto the support core.
